(19) United States
(12) Patent Application Publication
(10) Pub. No.: US 2025/0356253 A1
(43) Pub. Date: Nov. 20, 2025

(54) FEDERATED MACHINE LEARNING-BASED MODEL TRAINING METHODS AND APPARATUSES

(71) Applicant: Alipay (Hangzhou) Information Technology Co., Ltd., Hangzhou (CN)

(72) Inventors: Shuheng SHEN, Hangzhou (CN); Xinyi FU, Hangzhou (CN); Weiqiang WANG, Hangzhou (CN)

(21) Appl. No.: 18/872,368

(22) PCT Filed: Aug. 11, 2023
(86) PCT No.: PCT/CN2023/112501

§ 371 Date: Dec. 6, 2024

(30) Foreign Application Priority Data
Nov. 3, 2022 (CN) 202211369556.9

(51) Int. Cl. G06N 20/00; H04L 9/00

(52) U.S. Cl. CPC G06N 20/00; H04L 9/008

(57) ABSTRACT

Embodiments of this specification provide federated machine learning-based model training methods and apparatuses. At least two clients and at least one cloud server participate in federated machine learning-based model training. In each round of training, a first client receives a global model delivered by the cloud server; the first client obtains, through training, a gradient of the global model by using local private data; the first client encrypts the gradient obtained in the current round of training, and then sends an encrypted gradient to the cloud server; and the first client performs a next round of training until the global model converges.

### TECHNICAL FIELD

One or more embodiments of this specification relate to computer technologies, and in particular, to federated machine learning-based model training methods and apparatuses.

### BACKGROUND

Federated machine learning is a distributed machine learning framework with privacy protection, which can effectively help a plurality of clients use data and perform machine learning-based modeling in compliance with privacy protection, data security and government regulations. As a distributed machine learning paradigm, the federated machine learning can effectively resolve a problem of data silos, so that clients jointly perform modeling without sharing local data, implement intelligent collaboration, and jointly train a global model with better performance.

During federated machine learning-based model training, in each round of training, a central cloud server delivers a global model to each client, and each client obtains, through training, a gradient of a model parameter by using private local data, and then transmits the gradient obtained through training in the round of training to the cloud server. After collecting each gradient, the cloud server calculates an average gradient, updates the global model at the cloud server end by using the average gradient, and delivers an updated global model to each client in a next round of training.

It can be learned that, during federated machine learning-based global model training, each client needs to send the gradient obtained through training by the client to the cloud server. In many attack scenarios, gradient information sent by the client to the cloud server can be used to recover the original private data locally stored by the client, causing leakage of the private data, unprotected privacy of the user, and poor security.

### SUMMARY

One or more embodiments of this specification describe federated machine learning-based model training methods and apparatuses, to improve security of model training.

According to a first aspect, a federated machine learning-based model training method is provided, where at least two clients and at least one cloud server participate in federated machine learning-based model training, and the method is applied to any first client in the at least two clients, and includes: In each round of training, the first client receives a global model delivered by the cloud server; the first client obtains, through training, a gradient of the global model by using local private data; the first client encrypts the gradient obtained in the current round of training, and then sends an encrypted gradient to the cloud server; and the first client performs a next round of training until the global model converges.

The method further includes: The first client obtains a mask corresponding to the first client, where a sum of all masks corresponding to all clients that participate in the model training is less than a predetermined value. That the first client encrypts the gradient obtained in the current round of training includes: The first client adds the gradient obtained in the current round of training to the mask corresponding to the first client, to obtain the encrypted gradient.

The sum of all the masks corresponding to all the clients is 0.

That the first client obtains a mask corresponding to the first client includes: The first client obtains each sub-mask s(u, vⱼ) generated by the first client and corresponding to each of other clients in all the clients; the first client obtains a sub-mask s(vⱼ, u) generated by each of the other clients and corresponding to the first client, where j is a variable with a value from 1 to N, N is a quantity of all the clients that participate in the model training minus 1, u represents the first client, vⱼ represents the j^{th} client in all the clients that participate in the model training except the first client; for each variable j, the first client calculates a difference between s(u, vⱼ) and s(vⱼ, u), and obtains p(u, vⱼ) based on the difference; and the first client calculates Σⱼ₌₁^{N} p(u, vⱼ), and uses a result obtained through calculation as the mask corresponding to the first client.

The obtaining p(u, vⱼ) based on the difference includes: directly using the difference as p(u, vⱼ); or calculating the difference mod r, and using a modulo result obtained through calculation as p(u, vⱼ), where mod is a modulo operation, and r is a predetermined value greater than 1.

Here, r is a prime number not less than 200.

The method further includes: The first client generates a homomorphic encryption key pair corresponding to the first client; the first client sends a public key in the homomorphic encryption key pair corresponding to the first client to a forwarding server; and the first client receives a public key corresponding to each of the other clients in all the clients and sent by the forwarding server. Accordingly, after the first client obtains each sub-mask s(u, vⱼ) generated by the first client and corresponding to each of the other clients in all the clients, the method further includes: for each of the other clients, the first client encrypts the sub-mask s(u, vⱼ) corresponding to the j^{th} client by using a public key corresponding to the fa client, and sends encrypted s(u, vⱼ) to the forwarding server. Accordingly, that the first client obtains a sub-mask s(vⱼ, u) generated by each of the other clients and corresponding to the first client includes: The first client receives an encrypted sub-mask s(vⱼ, u) generated by each of the other clients, sent by the forwarding server, and corresponding to the first client; and the first client decrypts each encrypted sub-mask s(vⱼ, u) by using a private key in the homomorphic encryption key pair corresponding to the first client, to obtain each sub-mask s(vⱼ, u).

The forwarding server includes the cloud server or a third-party server independent of the cloud server.

According to a second aspect, a federated machine learning-based model training method is provided, where at least two clients and at least one cloud server participate in federated machine learning-based model training, and the method is applied to a cloud server, and includes: In each round of training, the cloud server delivers a latest obtained global model to each client that participates in the federated machine learning-based model training; the cloud server receives an encrypted gradient that is of the global model and that is sent by each client; the cloud server adds each received encrypted gradient of the global model, to obtain an aggregated gradient; the cloud server updates the global model by using the aggregated gradient; and the cloud server performs a next round of training until the global model converges.

According to a third aspect, a federated machine learning-based model training apparatus is provided, where at least two clients and at least one cloud server participate in federated machine learning-based model training, the apparatus is used in any first client in the at least two clients, and the apparatus includes: a global model obtaining module, configured to receive, in each round of training, a global model delivered by the cloud server; a gradient obtaining module, configured to obtain, through training in each round of training, a gradient of the global model by using local private data; and an encryption module, configured to: in each round of training, encrypt the gradient obtained in the current round of training, and then send an encrypted gradient to the cloud server, where each module performs a next round of training until the global model converges.

According to a fourth aspect, a federated machine learning-based model training apparatus is provided, where at least two clients and at least one cloud server participate in federated machine learning-based model training, the apparatus is used in the cloud server, and the apparatus includes: a global model delivery module, configured to deliver, in each round of training, a latest obtained global model to each client that participates in the federated machine learning-based model training; a gradient receiving module, configured to receive, in each round of training, an encrypted gradient that is of the global model and that is sent by each client; a gradient aggregation module, configured to add, in each round of training, each received encrypted gradient of the global model, to obtain an aggregated gradient; and a global model update module, configured to: in each round of training, update the global model by using the aggregated gradient, where each module performs a next round of training until the global model converges.

According to a fifth aspect, a computing device is provided, including a memory and a processor. The memory stores executable code, and when the processor executes the executable code, the method according to any embodiment of this specification is implemented.

The method and the apparatus provided in the embodiments of the present specification can implement the following beneficial effects separately or in combination: 1. After obtaining the gradient, the client does not directly send the gradient information to the cloud server, but first encrypts the gradient, and sends the encrypted information to the cloud server. As such, the cloud server obtains the encrypted gradient from each client instead of the original text of the gradient. In other words, the cloud server can only obtain the aggregated gradient, but cannot obtain the gradient of each client. Therefore, security is improved. For example, an attacker cannot steal the original text of the gradient from a transmission link from the client to the cloud server or from the cloud server, so that private data in the terminal device in which the client is located cannot be recovered through a generative adversarial network (GAN). The client can hold privacy by itself. This greatly improves security.
2. The sub-mask is encrypted by using homomorphic encryption during secret sharing. To be specific, each client does not send the original text of the sub-mask to the forwarding server, but sends the sub-mask encrypted by the public key in the homomorphic encryption key pair. This further improves security.
3. Compared with a sub-mask obtaining method in which the sub-masks are exchanged between the clients in pairs, in the embodiments of this specification, the sub-mask is encrypted by using homomorphic encryption during secret sharing, and can be forwarded by using the central cloud server or a third-party server as an intermediate third-party. This avoids a problem of a sub-mask leakage caused by exchanging the sub-masks between the clients in pairs, and further improves security.
4. When a difference between two sub-masks is calculated, the difference is used to take a modulo, and a modulo result is used to obtain the mask corresponding to the client, so that it can be ensured that a value range of a mask obtained through calculation does not exceed the maximum value that can be carried in the protocol. This increases an application range of the embodiments of this specification. For example, when a quantity of clients that participate in federated machine learning-based model training is large, model training in the embodiments of this specification can still be implemented.

### BRIEF DESCRIPTION OF DRAWINGS

To describe the technical solutions in the embodiments of this specification or in the conventional technology more clearly, the following briefly describes the accompanying drawings needed for describing the embodiments or the conventional technology. Clearly, the accompanying drawings in the following descriptions show some embodiments of this specification, and a person of ordinary skill in the art can still derive other drawings from these accompanying drawings without creative efforts.

FIG. 1 is a schematic diagram illustrating a structure of a system to which an embodiment of this specification is applied;

FIG. 2 is a flowchart illustrating a federated machine learning-based model training method executed by a client, according to an embodiment of this specification:

FIG. 3 is a flowchart illustrating a method in which a first client obtains a mask corresponding to the first client, according to an embodiment of this specification;

FIG. 4 is a flowchart illustrating a federated machine learning-based model training method executed by a cloud server, according to an embodiment of this specification:

FIG. 5 is a flowchart illustrating a federated machine learning-based model training method implemented by a client and a cloud server through collaboration, according to an embodiment of this specification;

FIG. 6 is a schematic structural diagram illustrating a federated machine learning-based model training apparatus used in a client, according to an embodiment of this specification;

FIG. 7 is a schematic structural diagram illustrating a federated machine learning-based model training apparatus used in a client, according to an embodiment of this specification; and

FIG. 8 is a schematic structural diagram illustrating a federated machine learning-based model training apparatus used in a cloud server, according to an embodiment of this specification.

### DESCRIPTION OF EMBODIMENTS

As described above, each client needs to send the gradient trained by the client to the cloud server. However, in many attack scenarios, the attacker may recover the original private data in the terminal device in which the client is located by using gradient information sent by the client to the cloud server, for example, recover the private data through a generative adversarial network (GAN). For another example, the central cloud server receives gradient information of individual clients. Generally, the central cloud server is reliable. However, when the central cloud server has an unintentional data loss behavior or conspiracy with another client, private data of the client is leaked. The client cannot hold the privacy by itself.

The solutions provided in this specification are described below with reference to the accompanying drawings.

To facilitate understanding of this specification, a system architecture used in this specification is first described. As shown in FIG. 1, the system architecture mainly includes M clients and a cloud server that participate in federated machine learning. M is a positive integer greater than 1. Each client interacts with the cloud server through a network. The network can include various connection types such as wired and wireless communication links, or fiber optic cables.

The M clients are respectively located in M terminal devices. Each client may be located in any terminal device that performs modeling through federated machine learning, such as a bank device, a payer device, or a mobile terminal, and the cloud server may be located in the cloud.

The method in the embodiments of this specification relates to client processing and cloud server processing. The following separately provides descriptions.

First, a model training method executed by the client is described.

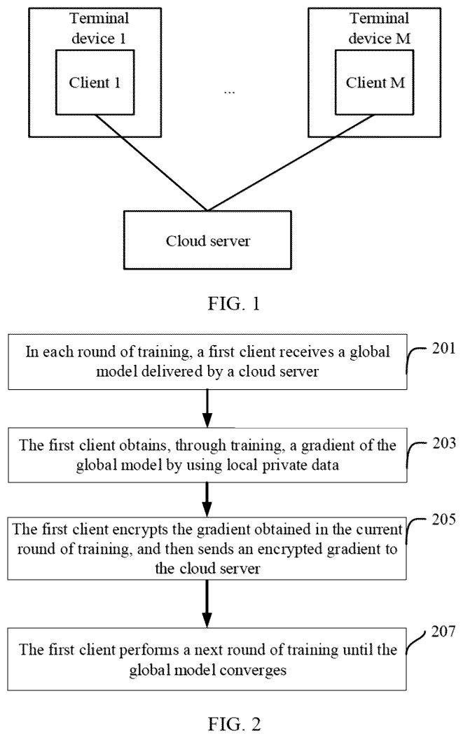

FIG. 2 is a flowchart illustrating a federated machine learning-based model training method executed by a client, according to an embodiment of this specification. The method is executed by each client in the federated machine learning. It can be understood that the method can alternatively be performed by any apparatus, device, platform, or device cluster having computing and processing capabilities. As shown in FIG. 2, the method includes step 201 to step 207.

Step 201: In each round of training, a first client receives a global model delivered by a cloud server.

Step 203: The first client obtains, through training, a gradient of the global model by using local private data.

Step 205: The first client encrypts the gradient obtained in the current round of training, and then sends an encrypted gradient to the cloud server.

Step 207: The first client performs a next round of training until the global model converges.

It can be learned from the above-mentioned procedure shown in FIG. 2 that, in the method provided in this embodiment of this specification, after obtaining the gradient, the client does not directly send the gradient information to the cloud server, but first encrypts the gradient, and sends the encrypted information to the cloud server. As such, the cloud server obtains the encrypted gradient from each client instead of the original text of the gradient. Therefore, security is improved. For example, an attacker cannot steal the original text of the gradient from a transmission link from the client to the cloud server or from the cloud server, so that private data in the terminal device in which the client is located cannot be recovered through a generative adversarial network (GAN). The client can hold privacy by itself. This greatly improves security.

The method in this embodiment of this specification may be applied to various service scenarios in which model training is performed based on federated machine learning, such as “ant forest” products of ALIPAY, and risk control of scanning code images.

The following describes each step in FIG. 2 with reference to one or more specific embodiments.

First, for step 201, in each round of training, the first client receives the global model delivered by the cloud server.

For ease of description, to better distinguish between a client that currently performs processing and another client, a client that performs the model training method in FIG. 2 is denoted as the first client. It may be understood that in this embodiment of this specification, the first client is each client that participates in the federated machine learning-based model training. In other words, each client that participates in the federated machine learning-based model training needs to perform the model training method described with reference to FIG. 2.

Next, for step 203, the first client obtains, through training, the gradient of the global model by using the local private data.

Next, for step 205, the first client encrypts the gradient obtained in the current round of training, and then sends the encrypted gradient to the cloud server.

In the method in this embodiment of this specification, the following two requirements need to be met: 1. Security: To meet the security, the client cannot directly send the original text of the gradient obtained through training by the client to the cloud server, but send the ciphertext of the gradient. 2. Availability: To perform model training, the cloud server needs to obtain an aggregation result of each gradient of each client, and the aggregation result needs to be equal to or close to an aggregation result of the original text of each gradient, so that model training can be better performed. In other words, although the cloud server cannot directly obtain the original text of each gradient, the obtained gradient aggregation result needs to be equal to or close to the aggregation result of the original text of each gradient. Therefore, encryption processing of all the clients that participate in the model training needs to ensure that a sum of all passwords attached to the gradients can or is close to offset from each other. A simple example is used to describe the idea. For example, a result Y needs to be obtained. One calculation method is Y=X1+X2, and another calculation method is Y=(X1+S)+(X2−S). To meet the requirement 2, the method in this embodiment of this specification uses the latter calculation idea.

In this case, in some embodiments of this specification, before step 205, the method further includes step A: The first client obtains a mask corresponding to the first client.

It is worthwhile to note that a sum of all masks corresponding to all the clients that participate in the model training is less than a predetermined value. Further, the sum of all the masks corresponding to all the clients is 0. Because the sum of all the masks is less than the predetermined value and may even be 0, it can be ensured that subsequent processing of gradient encryption by using the mask has little or no effect on a value of the gradient sum of each client. As such, an implementation process of step 205 includes: The first client adds the gradient obtained in the current round of training to the mask corresponding to the first client, to obtain the encrypted gradient.

Each client has a mask corresponding to the client. For example, there are 100 clients that participate in the federated machine learning-based model training method, and each client obtains a mask corresponding to the client. To further improve security, masks corresponding to different clients are different.

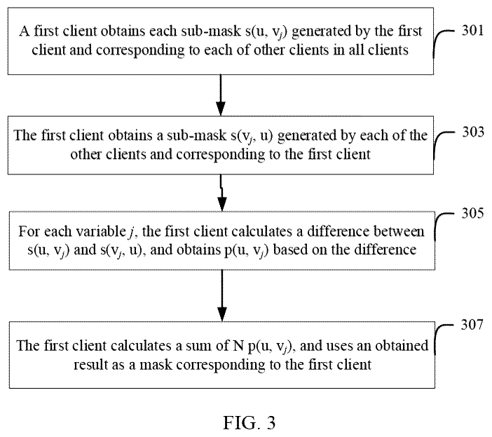

In some embodiments of this specification, as shown in FIG. 3, an implementation process in which the first client obtains the mask corresponding to the first client in step A includes step 301 to step 307.

Step 301: The first client obtains each sub-mask s(u, vⱼ) generated by the first client and corresponding to each of other clients in all the clients.

For example, there are 100 clients that participate in the federated machine learning-based model training method. In this case, for the 99 other clients, the first client separately generates 99 sub-masks s(u, vⱼ) corresponding to the 99 other clients. For example, s(u, v₁) represents a sub-mask generated by the first client and corresponding to client 1 in the other 99 clients. Similarly, s(u, v₂) represents a sub-mask generated by the first client and corresponding to client 2 in the other 99 clients. By analogy, s(u, v₉₉) represents a sub-mask generated by the first client and corresponding to client 99.

Step 303: The first client obtains a sub-mask s(vⱼ, u) generated by each of the other clients and corresponding to the first client, where j is a variable with a value from 1 to N, N is a quantity of all the clients that participate in the model training minus 1, u represents the first client, vⱼ represents the j^{th} client in all the clients that participate in the model training except the first client.

All the clients that participate in the federated machine learning-based model training method perform the processing in step 301. Therefore, each of the other clients also generates a sub-mask corresponding to the first client. In step 303, the first client needs to obtain all sub-masks s(vⱼ, u) generated by the other clients and corresponding to the first client.

For example, there are 100 clients that participate in the federated machine learning-based model training method. In this case, the first client needs to obtain 99 sub-masks s(vⱼ, u) generated by the other 99 clients and corresponding to the first client. Here, s(v₁, u) represents a sub-mask generated by client 1 in the other 99 clients and corresponding to the first client; and s(v₂, u) represents a sub-mask generated by client 2 in the other 99 clients and corresponding to the first client. By analogy, s(v₉₉, u) represents a sub-mask generated by client 99 in the other 99 clients and corresponding to the first client.

For example, there are 100 clients that participate in the federated machine learning-based model training method. After step 303 is performed, the first client obtains 99 sub-masks generated by the first client and corresponding to the other 99 clients and 99 sub-masks generated by the other 99 clients and corresponding to the first client, namely, a total of 198 sub-masks.

To enable each client that participates in the model training to obtain sub-masks generated by other clients and corresponding to the client, after step 301, the first client needs to send all the sub-masks generated by the first client to the cloud server or a third-party server. After receiving the sub-masks, the cloud server or the third-party server forwards the sub-masks to the corresponding clients. However, if the cloud server or the third-party server obtains the original text of the sub-mask, a problem of subsequently obtaining the original text of the gradient based on the sub-mask may be caused. Therefore, to further improve security, in some embodiments of this specification, the sub-mask may be encrypted, and all the sub-masks sent to the cloud server or the third-party server are encrypted sub-masks. As such, the cloud server or the third-party server cannot obtain both the original text of the gradient of each client and the original text of the sub-mask generated by each client. This greatly improves security.

To implement the effect that the cloud server or the third-party server cannot obtain the original text of the sub-mask, the method further includes: The first client generates a homomorphic encryption key pair corresponding to the first client, where the homomorphic encryption key pair corresponding to the first client is a homomorphic encryption key pair dedicated to the first client, instead of a homomorphic encryption key pair shared by all the clients. Therefore, homomorphic encryption key pairs corresponding to different clients are different. The first client sends a public key in the homomorphic encryption key pair corresponding to the first client to a forwarding server; and the first client receives a public key corresponding to each of the other clients in all the clients and sent by the forwarding server. Accordingly, after step 301, the method further includes: for each of the other clients, the first client encrypts the sub-mask s(u, vⱼ) corresponding to the j^{th} client by using a public key corresponding to the j^{th} client, and sends encrypted s(u, vⱼ) to the forwarding server, so that the forwarding server sends the encrypted s(u, vⱼ) to the corresponding j^{th} client. Accordingly, a process of step 303 includes: The first client receives an encrypted sub-mask s(vⱼ, u) generated by each of the other clients, sent by the forwarding server, and corresponding to the first client; and the first client decrypts each encrypted sub-mask s(vⱼ, u) by using a private key in the homomorphic encryption key pair corresponding to the first client, to obtain each sub-mask s(vⱼ, u).

The forwarding server includes the cloud server or a third-party server independent of the cloud server.

Step 305: For each variable j, the first client calculates a difference between s(u, vⱼ) and s(vⱼ, u), and obtains p(u, vⱼ) based on the difference.

For example, there are 100 clients that participate in the federated machine learning-based model training method, that is, j=99. In this case, in step 305, 99 differences need to be calculated. To be specific, corresponding to client 1 in the other 99 clients, a difference between s(u, v₁) and s(v₁, u) needs to be calculated. Corresponding to client 2 in the other 99 clients, a difference between s(u, v₂) and s(v₂, u) needs to be calculated. By analogy, corresponding to client 99 in the other 99 clients, a difference between s(u, v₉₉) and s(v₉₉, u) needs to be calculated.

It is worthwhile to note that, when the difference between s(u, v₁) and s(v₁, u) is calculated, either of s(u, v₁) and s(v₁, u) can be used as a minuend or a subtrahend, provided that it is ensured that all the clients calculate the difference between the two by using the same method. For example, s(u, vⱼ) generated by the client itself is used as a minuend, s(vⱼ, u) generated by the j^{th} client is used as the subtrabend.

In some embodiments of this specification, method 1 is used in an implementation process of step 305, and includes: Directly use the difference obtained through calculation as p(u, vⱼ).

Alternatively, in some other embodiments of this specification, method 2 is used in an implementation process of step 305, and includes: Perform mod r on the difference obtained through calculation, and use a modulo result as p(u, vⱼ), where mod is a modulo operation, and r is a predetermined value greater than 1.

During actual service implementation, a quantity of clients that participate in the model training may be very large. For example, there are 20,000 clients. In this case, each client needs to calculate 19999 differences according to the processing in step 305, and then add the 19999 differences in step 307. A value of a result obtained through adding is very large, and is likely to exceed the maximum value that can be carried in the protocol. Subsequently, the cloud server needs to add 20,000 masks obtained by 20,000 clients, and each mask is a sum of the 19999 differences. Therefore, even if a value of a mask in one client does not exceed the maximum value that can be carried in the protocol, a value that needs to be calculated by the cloud server subsequently may exceed the maximum value that can be carried in the protocol. Therefore, to further avoid a problem that a value is out of range when the quantity of clients that participate in the model training is large, in this embodiment of this specification, in step 305, each time a difference is calculated, a modulo operation is performed on r by using the difference. As such, all the differences are r times smaller overall, to ensure that the value is a value that can be carried in the protocol. Here, r may be as large as possible, to limit all the differences to a maximum extent as much as possible. For example, r is a prime number not less than 200.

It may be understood that mod processing does not affect that the mask sum is less than the predetermined value or the mask sum is equal to 0. Whether a modulo operation is performed by using the difference, that is, either method 1 or method 2 is used, subsequent effects of making the sum of all the masks of all the clients less than the predetermined value or 0 are the same.

Step 307: The first client calculates

$${\sum }_{j = 1}^{N} p ( u , {v}_{j} ) ,$$

and uses a result obtained through calculation as the mask corresponding to the first client.

For example, there are 100 clients that participate in the federated machine learning-based model training method, that is, j=99. In this case, according to the processing in step 307, the first client needs to calculate a sum of 99 p(u, vⱼ), and use the sum value as the mask corresponding to the first client.

It can be learned from the procedure shown in FIG. 3 that the mask corresponding to the first client is obtained based on the sum of all p(u, vⱼ), and each p(u, vⱼ) is obtained based on the difference between s(u, vⱼ) and s(vⱼ, u). As such, if all the masks p(u, vⱼ) of all the clients are added, the mask values are offset, to eliminate the effect of using the masks on the gradient encryption.

As described above, in step 205, the first client adds the gradient obtained in the current round of training to the mask corresponding to the first client, to obtain the encrypted gradient. For example, in the current round of training, the gradient obtained by the first client is x(u), and the mask corresponding to the first client is Σᵥp(u, v) obtained in step 307. In this case, in step 205, the first client calculates y(u)=x(u)+Σᵥ p(u, v), and sends y(u) to the cloud server.

Next, step 207 is performed, where the first client performs the next round of training until the global model converges.

The following describes processing performed by the cloud server in the federated machine learning-based model training.

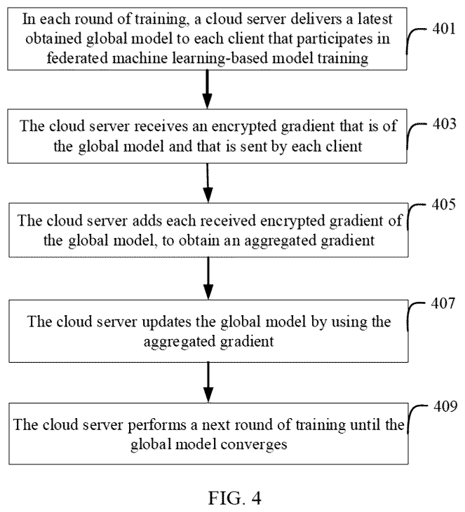

FIG. 4 is a flowchart illustrating a federated machine learning-based model training method executed by a cloud server, according to an embodiment of this specification. At least two clients and at least one cloud server participate in federated machine learning-based model training, and the method is executed by the cloud server that participates in the federated machine learning. It can be understood that the method can alternatively be performed by any apparatus, device, platform, or device cluster having computing and processing capabilities. As shown in FIG. 4, the method includes step 401 to step 409.

Step 401: In each round of training, the cloud server delivers a latest obtained global model to each client that participates in the federated machine learning-based model training.

Step 403: The cloud server receives an encrypted gradient that is of the global model and that is sent by each client.

Step 405: The cloud server adds each received encrypted gradient of the global model, to obtain an aggregated gradient.

Step 407: The cloud server updates the global model by using the aggregated gradient.

Step 409: The cloud server performs a next round of training until the global model converges.

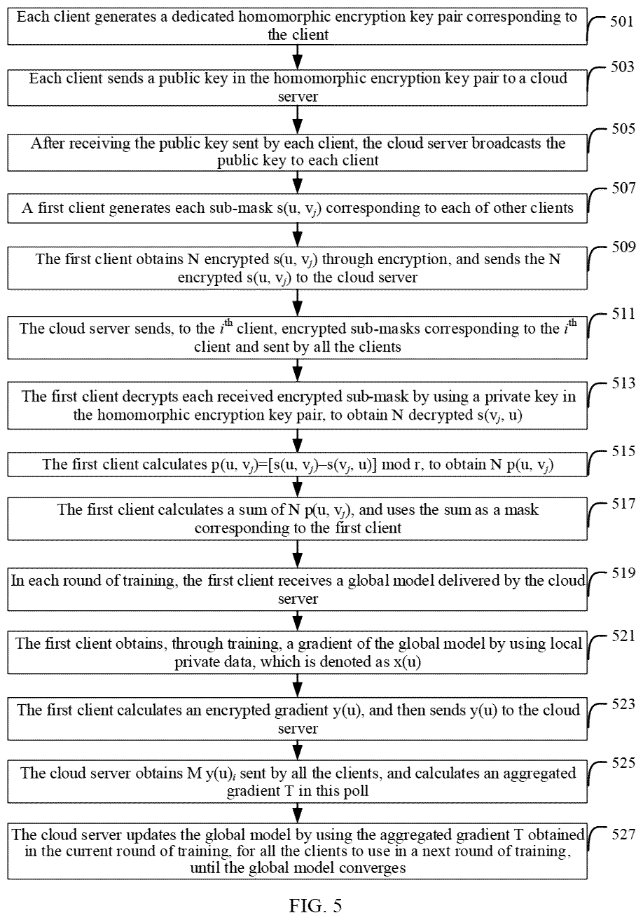

For descriptions of processing performed by the cloud server, reference may be further made to descriptions of the embodiments of this specification with reference to FIG. 2. FIG. 3, and FIG. 5.

With reference to the client processing and the cloud server processing, the following describes a federated machine learning-based model training method in some embodiments of this specification. FIG. 5 is a flowchart illustrating a federated machine learning-based model training method implemented by a client and a cloud server through collaboration, according to an embodiment of this specification. As shown in FIG. 5, the method includes step 501 to step 527.

Step 501: Each client generates a dedicated homomorphic encryption key pair corresponding to the client.

Step 503: Each client sends a public key in the homomorphic encryption key pair corresponding to the client to the cloud server.

Step 505: After receiving the public key sent by each client, the cloud server broadcasts the public key to each client, so that each client obtains public keys corresponding to all clients that participate in model training.

Step 507: A first client generates each sub-mask s(u, vⱼ) corresponding to each of other clients in all the clients.

In the following steps, for ease of description, processing performed by the first client is used as an example for description. The processing performed by the first client is processing performed by each client that participates in the model training.

Step 509: For other N clients, the first client encrypts s(u, vⱼ) corresponding to the j^{th} client by using a public key corresponding to the j^{th} client, to obtain an encrypted sub-mask corresponding to the j^{th} client, where j is a variable with a value from 1 to N, N is a quantity of all the clients that participate in the model training minus 1; and then sends all N encrypted sub-masks s(u, vⱼ) to the cloud server.

Step 511: The cloud server sends, to the i^{th} client, encrypted sub-masks corresponding to the i^{th} client and sent by all the clients, where i is a variable with a value from 1 to M, and M is a quantity of all the clients that participate in the model training.

Step 513: The first client receives each encrypted sub-mask corresponding to the first client, and decrypts each encrypted sub-mask by using a private key in the dedicate homomorphic encryption key pair corresponding to the first client, to obtain N decrypted s(vⱼ, u).

Step 515: For each variable j, the first client calculates p(u, vⱼ)=[s(u vⱼ)−s(vⱼ, u)] mod r, to obtain N p(u, vⱼ).

Step 517: The first client calculates

$${\sum }_{j = 1}^{N} p ( u , {v}_{j} ) ,$$

and uses a result obtained through calculation as the mask corresponding to the first client.

The process of step 501 to step 517 may be performed once when each client starts. In each round of training subsequently, N masks p(u, vⱼ) are directly used, that is, the mask used by the first client in each round of training is the same. Alternatively, the process of step 501 to step 517 may be performed once in each round of training, so that the mask used by the first client in each round of training is different, to further improve security.

Step 519: In each round of training, the first client receives a global model delivered by the cloud server.

Step 521: The first client obtains, through training, a gradient of the global model by using local private data, which is denoted as x(u).

Step 523: The first client calculates an encrypted gradient

$$y ( u ) = x ( u ) + {\sum }_{j = 1}^{N} p ( u , {v}_{j} ) ,$$

and then sends y(u) to the cloud server.

Step 525: The cloud server obtains M y(u); sent by all the clients, and calculates an aggregated gradient

$$T = {\sum }_{i = 1}^{M} {y ( u )}_{i}$$

in this poll, where i is a variable, and M is the quantity of all the clients that participate in the model training.

$$T = {\sum }_{i = 1}^{M} {y ( u )}_{i} = {\sum }_{i = 1}^{M} {x ( u )}_{i} + {\sum }_{u} {\sum }_{v} p ( u , v ) ≡ {\sum }_{i = 1}^{M} {x ( u )}_{i} mod$$

Step 527: The cloud server updates the global model by using the aggregation gradient T obtained in the current round of training, for all the clients to use in a next round of training, until the global model converges.

As such, the global model is obtained.

Some embodiments of this specification further provide a service prediction method. The method includes: performing service prediction by using a trained global model, for example, performing risk user identification.

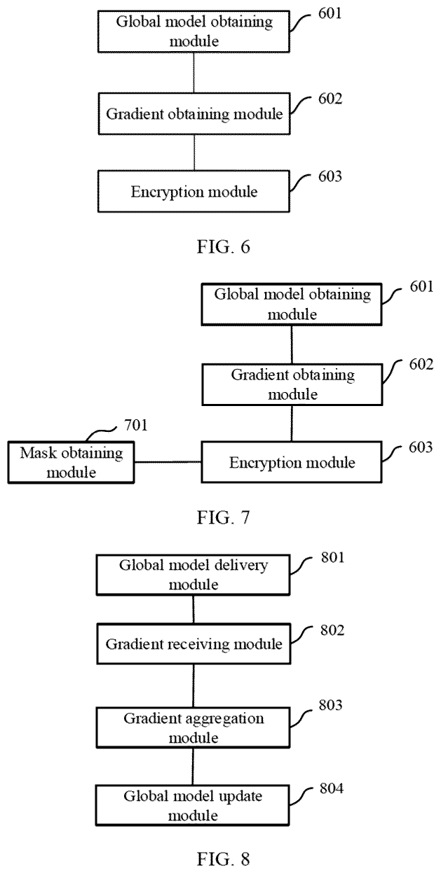

Some embodiment of this specification further provide a federated machine learning-based model training apparatus, where at least two clients and at least one cloud server participate in federated machine learning-based model training, and the apparatus is used in any first client in the at least two clients. As shown in FIG. 6, the apparatus includes: a global model obtaining module 601, configured to receive, in each round of training, a global model delivered by the cloud server; a gradient obtaining module 602, configured to obtain, through training in each round of training, a gradient of the global model by using local private data; and an encryption module 603, configured to: in each round of training, encrypt the gradient obtained in the current round of training, and then send an encrypted gradient to the cloud server, where each module performs a next round of training until the global model converges.

In the apparatus embodiments of this specification, as shown in FIG. 7, the apparatus further includes the mask obtaining module 701. The mask obtaining module 701 is configured to obtain a mask corresponding to the first client in which the apparatus is located. A sum of all masks corresponding to all clients that participate in the model training is less than a predetermined value. During encryption, the encryption module 603 is configured to add the gradient obtained in the current round of training to the mask corresponding to the first client, to obtain the encrypted gradient.

In the apparatus embodiments of this specification shown in FIG. 6 and FIG. 7, the sum of all the masks corresponding to all the clients is 0.

In the apparatus embodiments of this specification shown in FIG. 7, the mask obtaining module 701 is configured to: obtain each sub-mask s(u, vⱼ) generated by the first client and corresponding to each of other clients in all the clients; obtain a sub-mask s(vⱼ, u) generated by each of the other clients and corresponding to the first client, where j is a variable with a value from 1 to N, N is a quantity of all the clients that participate in the model training minus 1, u represents the first client, vⱼ represents the j^{th} client in all the clients that participate in the model training except the first client; for each variable j, calculate a difference between s(u, vⱼ) and s(vⱼ, u), and obtain p(u, vⱼ) based on the difference; calculate

$${\sum }_{j = 1}^{N} p ( u , {v}_{j} ) ,$$

and use a result obtained through calculation as the mask corresponding to the first client.

In the apparatus embodiments of this specification shown in FIG. 7, the mask obtaining module 701 is configured to: directly use the difference as p(u, vⱼ); or calculate the difference mod r, and use a modulo result obtained through calculation as p(u, vⱼ), where mod is a modulo operation, and r is a predetermined value greater than 1.

In the apparatus embodiments of this specification shown in FIG. 7, r is a prime number not less than 200.

In the apparatus embodiments of this specification shown in FIG. 7, the mask obtaining module 701 is further configured to: generate a homomorphic encryption key pair corresponding to the first client; send a public key in the homomorphic encryption key pair corresponding to the first client to a forwarding server; and receive a public key corresponding to each of the other clients in all the clients and sent by the forwarding server. Accordingly, the mask obtaining module 701 is configured to: after each sub-mask s(u, vⱼ) generated by the first client and corresponding to each of the other clients in all the clients is obtained, for each of the other clients, encrypt the sub-mask s(u, vⱼ) corresponding to the j^{th} client by using a public key corresponding to the j^{th} client, and send encrypted s(u, vⱼ) to the forwarding server; receive an encrypted sub-mask s(vⱼ, u) generated by each of the other clients, sent by the forwarding server, and corresponding to the first client; and decrypt each encrypted sub-mask s(vⱼ, u) by using a private key in the homomorphic encryption key pair corresponding to the first client, to obtain each sub-mask s(vⱼ, u).

The forwarding server includes the cloud server or a third-party server independent of the cloud server.

Some embodiments of this specification provide a federated machine learning-based model training apparatus, where at least two clients and at least one cloud server participate in federated machine learning-based model training, and the apparatus is used in the cloud server. As shown in FIG. 8, the apparatus includes: a global model delivery module 801, configured to deliver, in each round of training, a latest obtained global model to each client that participates in the federated machine learning-based model training; a gradient receiving module 802, configured to receive, in each round of training, an encrypted gradient that is of the global model and that is sent by each client; a gradient aggregation module 803, configured to add, in each round of training, each received encrypted gradient of the global model, to obtain an aggregated gradient; and a global model update module 804, configured to: in each round of training, update the global model by using the aggregated gradient, where each module performs a next round of training until the global model converges.

Some embodiments of this specification provide a computer-readable storage medium, where the computer-readable storage medium stores a computer program, and when the computer program is executed on a computer, the computer is enabled to perform the method according to any embodiment of this specification.

Some embodiments of this specification provide a computing device, including a memory and a processor, where the memory stores executable code, and the processor executes the executable code to implement the method according to any embodiment of this specification.

It can be understood that a structure shown in the embodiments of this specification does not constitute a specific limitation on the apparatus in the embodiments of this specification. In some other embodiments of this specification, the above-mentioned apparatus may include more or fewer components than those shown in the figure, or combine some components, or split some components, or have different component arrangements. The components in the figure can be implemented by hardware, software, or a combination of software and hardware.

Content such as information exchange and an execution process between the modules in the apparatus and the system is based on the same idea as the method embodiments of this specification. Therefore, for detailed content, references can be made to descriptions in the method embodiments of this specification. Details are omitted here for simplicity.

The embodiments of this specification are described in a progressive method. For same or similar parts in the embodiments, refer to each other. Each embodiment focuses on a difference from other embodiments. Particularly, the apparatus embodiments are basically similar to the method embodiments, and therefore are described briefly. For related parts, references can be made to related descriptions in the method embodiments.

A person skilled in the art should be aware that in the above-mentioned one or more examples, functions described in this specification can be implemented by hardware, software, firmware, or any combination thereof. When being implemented by software, these functions can be stored in a computer-readable medium or transmitted as one or more instructions or code on a computer-readable medium.

In the above-mentioned specific implementations, the objectives, technical solutions, and beneficial effects of this specification are further described in detail. It should be understood that the above-mentioned descriptions are implementations of this specification, but are not intended to limit the protection scope of this specification. Any modification, equivalent replacement, improvement, etc. made based on the technical solutions of this specification shall fall within the protection scope of this specification.

1. A federated machine learning-based model training method, wherein at least two clients and at least one cloud server participate in federated machine learning-based model training, and the method is applied to any first client in the at least two clients, and comprises:
in each round of training, receiving, by the first client, a global model delivered by the cloud server;
obtaining, by the first client through training, a gradient of the global model by using local private data;
encrypting, by the first client, the gradient obtained in the current round of training, and then sending an encrypted gradient to the cloud server; and
performing, by the first client, a next round of training until the global model converges.

2. The method according to claim 1, wherein the method further comprises: obtaining, by the first client, a mask corresponding to the first client, wherein a sum of all masks corresponding to all clients that participate in the model training is less than a predetermined value; and
encrypting, by the first client, the gradient obtained in the current round of training comprises:
adding, by the first client, the gradient obtained in the current round of training to the mask corresponding to the first client, to obtain the encrypted gradient.

3. The method according to claim 2, wherein the sum of all the masks corresponding to all the clients is 0.

4. The method according to claim 3, wherein obtaining, by the first client, the mask corresponding to the first client comprises:
obtaining, by the first client, each sub-mask s(u, vⱼ) generated by the first client and corresponding to each of other clients in all the clients;
obtaining, by the first client, a sub-mask s(vⱼ, u) generated by each of the other clients and corresponding to the first client, wherein j is a variable with a value from 1 to N, N is a quantity of all the clients that participate in the model training minus 1, u represents the first client, vⱼ represents the j^{th} client in all the clients that participate in the model training except the first client;
for each variable j, calculating, by the first client, a difference between s(u, vⱼ) and s(vⱼ, u), and obtaining p(u, vⱼ) based on the difference; and
calculating, by the first client,
$${\sum }_{j = 1}^{N} p ( u , {v}_{j} ) ,$$
and using a result obtained through calculation as the mask corresponding to the first client.

5. The method according to claim 4, wherein obtaining p(u, vⱼ) based on the difference comprises:
directly using the difference as p(u, vⱼ); or
calculating the difference mod r, and using a modulo result obtained through calculation as p(u, vⱼ), wherein mod is a modulo operation, and r is a predetermined value greater than 1.

6. The method according to claim 5, wherein r is a prime number not less than 200.

7. The method according to claim 4, wherein
the method further comprises: generating, by the first client, a homomorphic encryption key pair corresponding to the first client; sending, by the first client, a public key in the homomorphic encryption key pair corresponding to the first client to a forwarding server; and receiving, by the first client, a public key corresponding to each of the other clients in all the clients and sent by the forwarding server;
accordingly, after obtaining, by the first client, each sub-mask s(u, vⱼ) generated by the first client and corresponding to each of other clients in all the clients, the method further comprises: for each of the other clients, encrypting, by the first client, the sub-mask s(u, vⱼ) corresponding to the j^{th} client by using a public key corresponding to the j^{th} client, and sending encrypted s(u, vⱼ) to the forwarding server; and
accordingly, obtaining, by the first client, the sub-mask s(vⱼ, u) generated by each of the other clients and corresponding to the first client comprises:
receiving, by the first client, an encrypted sub-mask s(vⱼ, u) generated by each of the other clients, sent by the forwarding server, and corresponding to the first client; and
decrypting, by the first client, each encrypted sub-mask s(vⱼ, u) by using a private key in the homomorphic encryption key pair corresponding to the first client, to obtain each sub-mask s(vⱼ, u).

8. The method according to claim 7, wherein the forwarding server comprises the cloud server or a third-party server independent of the cloud server.

9. A federated machine learning-based model training method, wherein at least two clients and at least one cloud server participate in federated machine learning-based model training, and the method is applied to the cloud server, and comprises:
in each round of training, delivering, by the cloud server, a latest obtained global model to each client that participates in the federated machine learning-based model training;
receiving, by the cloud server, an encrypted gradient that is of the global model and that is sent by each client;
adding, by the cloud server, each received encrypted gradient of the global model, to obtain an aggregated gradient;
updating, by the cloud server, the global model by using the aggregated gradient; and
performing, by the cloud server, a next round of training until the global model converges.

10-11. (canceled)

12. A computing device, comprising a memory and a processor, wherein the memory stores executable code, and when the processor executes the executable code, the computing device is caused to implement a federated machine learning-based model training method, wherein at least two clients and at least one cloud server participate in federated machine learning-based model training, and the method is applied to any first client in the at least two clients, and comprises:
in each round of training, receiving, by the first client, a global model delivered by the cloud server;
obtaining, by the first client through training, a gradient of the global model by using local private data;
encrypting, by the first client, the gradient obtained in the current round of training, and then sending an encrypted gradient to the cloud server; and
performing, by the first client, a next round of training until the global model converges.

13. The computing device according to claim 12, wherein the method further comprises: obtaining, by the first client, a mask corresponding to the first client, wherein a sum of all masks corresponding to all clients that participate in the model training is less than a predetermined value; and
encrypting, by the first client, the gradient obtained in the current round of training comprises:
adding, by the first client, the gradient obtained in the current round of training to the mask corresponding to the first client, to obtain the encrypted gradient.

14. The computing device according to claim 13, wherein the sum of all the masks corresponding to all the clients is 0.

15. The computing device according to claim 14, wherein obtaining, by the first client, the mask corresponding to the first client comprises:
obtaining, by the first client, each sub-mask s(u, vⱼ) generated by the first client and corresponding to each of other clients in all the clients;
obtaining, by the first client, a sub-mask s(vⱼ, u) generated by each of the other clients and corresponding to the first client, wherein j is a variable with a value from 1 to N, N is a quantity of all the clients that participate in the model training minus 1, u represents the first client, vⱼ represents the j^{th} client in all the clients that participate in the model training except the first client;
for each variable j, calculating, by the first client, a difference between s(u, vⱼ) and s(vⱼ, u), and obtaining p(u, vⱼ) based on the difference; and
calculating, by the first client,
$${\sum }_{j = 1}^{N} p ( u , {v}_{j} ) ,$$
and using a result obtained through calculation as the mask corresponding to the first client.

16. The computing device according to claim 15, wherein obtaining p(u, vⱼ) based on the difference comprises:
directly using the difference as p(u, vⱼ); or
calculating the difference mod r, and using a modulo result obtained through calculation as p(u, vⱼ), wherein mod is a modulo operation, and r is a predetermined value greater than 1.

17. The computing device according to claim 16, wherein r is a prime number not less than 200.

18. The computing device according to claim 15, wherein
the method further comprises: generating, by the first client, a homomorphic encryption key pair corresponding to the first client; sending, by the first client, a public key in the homomorphic encryption key pair corresponding to the first client to a forwarding server; and receiving, by the first client, a public key corresponding to each of the other clients in all the clients and sent by the forwarding server;
accordingly, after obtaining, by the first client, each sub-mask s(u, vⱼ) generated by the first client and corresponding to each of other clients in all the clients, the method further comprises: for each of the other clients, encrypting, by the first client, the sub-mask s(u, vⱼ) corresponding to the j^{th} client by using a public key corresponding to the j^{th} client, and sending encrypted s(u, vⱼ) to the forwarding server; and
accordingly, obtaining, by the first client, the sub-mask s(vⱼ, u) generated by each of the other clients and corresponding to the first client comprises:
receiving, by the first client, an encrypted sub-mask s(vⱼ, u) generated by each of the other clients, sent by the forwarding server, and corresponding to the first client; and
decrypting, by the first client, each encrypted sub-mask s(vⱼ, u) by using a private key in the homomorphic encryption key pair corresponding to the first client, to obtain each sub-mask s(vⱼ, u).

19. The computing device according to claim 18, wherein the forwarding server comprises the cloud server or a third-party server independent of the cloud server.
